(19) United States
(12) Patent Application Publication
(10) Pub. No.: US 2010/0127421 A1
(43) Pub. Date: May 27, 2010

(54) BI-DIRECTIONAL FLOW FOR PROCESSING SHAPED BODIES

(76) Inventors: Leonard Charles Dabich, II, Painted Post, NY (US); Ronald Alan Davidson, Horseheads, NY (US); James Gerard Fagan, Painted Post, NY (US); Todd Benson Fleming, Elkland, PA (US)

Correspondence Address: CORNING INCORPORATED, SP-TI-3-1, CORNING, NY, 14831, US

(21) Appl. No.: 12/367,035

(22) Filed: Feb. 6, 2009

Related U.S. Application Data
(60) Provisional application No. 61/117,774, filed on Nov. 25, 2008.

(51) Int. Cl. B29C 71/02

(52) U.S. Cl. 264/236; 425/445

(57) ABSTRACT

Disclosed herein are methods of making shaped bodies, such as carbon-based, inorganic cement, or ceramic bodies. Methods disclosed herein may comprise applying a bidirectional gas flow to at least one heat treatment and/or controlled oxidation step. Also disclosed herein are methods of making shaped bodies comprising a single-step controlled oxidation firing process. Further disclosed herein are shaped bodies made by a process comprising applying a bi-directional gas flow to at least one heat treatment and/or controlled oxidation step, and shaped bodies made by a single-step controlled oxidation firing process. Further disclosed herein is a bidirectional gas flow furnace for the heat treatment and/or the controlled oxidation of a shaped body.

### CROSS-REFERENCE TO RELATED APPLICATION

This application claims the benefit of priority to U.S. Provisional Application No. 61/117,774, filed on Nov. 25, 2008.

### TECHNICAL FIELD

Disclosed herein are methods of making shaped bodies, such as carbon-based, inorganic cement, or ceramic bodies. Methods disclosed herein may comprise applying a bidirectional gas flow to heat treatment and/or controlled oxidation steps. Also disclosed herein are methods of making shaped bodies, comprising a single-step controlled oxidation firing process. Further disclosed herein are shaped bodies made by a process comprising applying a bidirectional gas flow to heat treatment and/or controlled oxidation steps, and shaped bodies made by a single-step controlled oxidation firing process. Further disclosed herein is a bidirectional gas flow furnace for the heat treatment and/or the controlled oxidation of a shaped body.

### BACKGROUND

Shaped bodies, including high surface area structures, may be used in a variety of applications. Such bodies may be used, for example, as supports for catalysts for carrying out chemical reactions or as sorbents/filters for the capture of particulate, liquid, or gaseous species from fluids such as gas streams and liquid streams. As an example, certain activated carbon bodies, such as honeycombs, may be used as catalyst substrates or for the capture of heavy metals from gas streams. For example, certain ceramic bodies may also be used as catalyst substrates or for the capture of particulates such as soot.

Shaped bodies may be manufactured by first subjecting an unprocessed or “green” shaped body to one or more heat treatments, and/or then subsequently subjecting the treated shaped body to one or more controlled oxidation firings. Providing a substantially uniformly oxidized shaped body with substantially uniform physical strength may be important to long term performance of the shaped body. Each firing, which is typically followed by a cooling period before a subsequent firing, can be time consuming.

The inventors have now discovered a technology referred to as bidirectional flow for alternating gas flow direction in a furnace during the heat treatment and controlled oxidation firing processes. This bidirectional flow process can be applied to any furnace, including both batch furnaces and continuous furnaces. Application of this bidirectional flow process may allow for shorter process time requirements and more uniformly processed shaped bodies. In various exemplary embodiments, the shaped body may be a monolithic structure comprising channels or porous networks permitting the flow of process gas through the monolith, for example, but not limited to, honeycomb shaped bodies comprising an inlet end, an outlet end, and a multiplicity of cells extending from one end to the other, wherein the cells are defined by intersecting cell walls. In at least one additional exemplary embodiment, the shaped body is a ceramic, inorganic cement, or carbon-based body, for example a ceramic honeycomb body.

### SUMMARY

In accordance with exemplary embodiments of the invention, the inventors have discovered methods for alternating the gas flow through and/or around shaped bodies during heat treatment processes and/or controlled oxidation firings. The embodiments disclosed herein may allow for shorter processing times because multiple firings and/or rotation of the shaped body may not be required. Additionally, in certain exemplary embodiments, the uniformity of the resultant shaped product may also be improved, as the residence time in the furnace and the frequency of alternating the gas flow may be managed in order to obtain greater uniformity during the heat treatment process and controlled activation firing or firings.

The bidirectional gas flow technology disclosed herein may be applied to any furnace, such as batch (e.g., retort, periodic) furnaces and continuous furnaces. Moreover, the shaped bodies, such as carbon-based, inorganic cement, or ceramic bodies, can be placed inside the furnace in both vertical and horizontal orientations to promote gas flow through and around the shaped body.

In accordance with various embodiments of the invention, the methods disclosed herein for bidirectional gas flow may reduce processing time by allowing controlled oxidation and potentially carbonization to occur in one furnace cycle/step, while still attaining substantial product uniformity. In certain exemplary embodiments, the typical three or four firing cycles (i.e., one to two heat treatment cycles and two controlled oxidation cycles) for processing shaped bodies may be reduced to one or two firings, for example two firings in batch furnaces (i.e., one furnace cycle for heat treatment and one furnace cycle for controlled oxidation).

In accordance with certain embodiments of the invention, the bi-directional gas flow design concept may also be readily applied to existing furnace design configurations by retrofitting the existing furnace with the addition of a gas manifold system and/or recirculation system to attain the desired bidirectional gas flow. The methods disclosed herein may, in various embodiments, be applied to both radiant heated furnace designs and recirculation designs. Moreover, a further embodiment disclosed herein is a bidirectional gas flow furnace for the heat treatment and/or the controlled oxidation of a shaped body.

In certain embodiments, the gas flow can be tailored to attain the desired product properties, such as substantial uniformity. For example, bi-directional gas flow may allow for the shaped bodies to be rapidly processed through a continuous furnace for high volume manufacturing. Bi-directional gas flow may likewise allow for significant cost savings, as multiple step firings can be reduced and/or eliminated and the number of furnaces used may be reduced. In accordance with exemplary embodiments of the invention, bidirectional gas flow can be applied when the shaped body is in either a vertical or a horizontal orientation.

Additional objects and advantages of the invention are set forth in the following description. Both the foregoing general summary and the following detailed description are exemplary only and are not restrictive of the invention as claimed. Further features and variations may be provided in addition to those set forth in the description. For instance, the present invention includes various combinations and subcombinations of the features disclosed in the detailed description. In addition, it will be noted that the order of the steps presented need not be performed in that order in order to practice the invention.

### BRIEF DESCRIPTION OF THE DRAWINGS

FIG. 1A is a schematic diagram of an exemplary bidirectional flow apparatus in an operational state wherein gas is flowing from left to right, according to one embodiment of the invention.

FIG. 1B is a schematic diagram of an exemplary bidirectional flow apparatus in an operational state wherein gas is flowing from right to left, according to one embodiment of the invention.

FIG. 2A is a design configuration for an exemplary bidirectional flow apparatus for use in a box retort furnace, according to one embodiment of the invention.

FIG. 2B is a design configuration of an exemplary cassette holder for use in a box retort furnace, according to one embodiment of the invention.

FIG. 3 is a partial front isometric view of an exemplary gas chamber configuration for an exemplary bidirectional flow apparatus for use in a box retort furnace, according to one embodiment of the invention.

### DESCRIPTION OF EXEMPLARY EMBODIMENTS

Disclosed herein are methods of making shaped bodies, such as, for example, ceramic, inorganic cement, or carbon-based bodies. In at least one exemplary embodiment, the methods disclosed herein may comprise applying a bi-directional gas flow to at least one heat treatment process and/or controlled oxidation step upon firing a green shaped body. In at least one further embodiment, the methods of making shaped bodies comprise a single-step controlled oxidation firing process. In a further embodiment, shaped bodies made by a process comprising applying a bidirectional gas flow to at least one heat treatment process and/or controlled oxidation step, and shaped bodies made by a single-step controlled oxidation firing process are disclosed. A further embodiment disclosed herein is a bidirectional gas flow furnace for the heat treatment and/or the controlled oxidation of a shaped body.

As used in the present disclosure, the term “shaped body,” and variations thereof, is intended to include ceramic, inorganic cement, and/or carbon-based bodies. Ceramic bodies include, but are not limited to, those comprised of cordierite and silicon carbide. Inorganic cement bodies include, but are not limited to, those comprised of inorganic materials comprised of an oxide, sulfate, carbonate, or phosphate of a metal, including calcium oxide, calcium aluminate cements, calcium/magnesium sulfate cements, and calcium phosphate. Carbon-based materials include, but are not limited to, synthetic carbon-based polymeric material (which may be cured or uncured); activated carbon powder; charcoal powder; coal tar pitch; petroleum pitch; wood flour; cellulose and derivatives thereof; natural organic materials, such as wood flour, nut-shell flour; starch; coke; coal; or mixtures thereof. In some embodiments, the carbon-based material comprises a phenolic resin or a resin based on furfuryl alcohol.

As disclosed above, firing of the shaped bodies typically comprises two steps: a heat treatment step and a controlled oxidation step. Heat treatments as described herein may include, for example, carbonization, which is a process that involves the thermal decomposition of the carbonaceous material, in, for example, a carbon-based or ceramic body, thereby eliminating low molecular weight species (e.g., carbon dioxide, water, and gaseous hydrocarbons) and producing a fixed carbon mass and a rudimentary pore structure in the carbon-based or ceramic body. Traditionally, during carbonization, the shaped body is heated to a high temperature, ranging from, for example, about 600° C. to 1000° C. for a period ranging from several minutes to several hours in an inert atmosphere (e.g., nitrogen, argon, helium, and mixtures thereof). Then, the shaped body is cooled and removed from the furnace. The process may be repeated one or more times.

In addition, the shaped body may undergo a controlled oxidation process. Controlled oxidation may include, for example, activation processes. The process of activation may allow the carbon in a carbon-based shaped body to form a microcrystalline structure, wherein the carbon has been processed to produce a high surface area body. Such carbon may be known as activated carbon. Activated carbon may be characterized by a high specific surface area (for example, 300 to 2500 m²/g), which may lead to high adsorptive capability. Traditionally, during controlled oxidation firings, the shaped body, which may be heated in an inert atmosphere (e.g., nitrogen, argon, helium, and mixtures thereof) to a high temperature, ranging from, for example, about 600° C. to 1000° C., is “soaked” in an oxidation gas (e.g., carbon dioxide, water, and mixtures thereof) prior to oxidation for anywhere from a few minutes to many hours to oxidize the shaped body. The shaped body is then cooled and removed from the furnace. The process may be repeated one or more times.

In various exemplary embodiments of the invention, the shaped bodies to be processed may be set into a cassette or other holder during the heat treatment step. The cassette containing the shaped body may then be loaded into the furnace, such as a retort furnace, between at least two gas diffusion chambers. The gas diffusion chambers may comprise gas feeds comprising valves that allow for the gas flow to be regulated. In certain embodiments, the valving may allow the gas flow to be turned on or off or the gas flow rate to be increased or decreased. In certain embodiments, gas diffusion manifolds and setter blocks, such as, for example, ceramic honeycomb setter blocks, may also be placed in the gas diffusion chambers to maximize gas flow uniformity.

According to at least one exemplary embodiment disclosed herein, the upper portion of the cassette inner frame may be allowed to move as the shaped body expands and contracts during firing. In certain embodiments, a gas seal can be maintained in the furnace by using a ceramic felt material and/or by maintaining close machine tolerances for interconnecting and/or sliding parts.

In various exemplary embodiments, once a shaped body and cassette are loaded into the furnace it may then be heated with gas flow in one or more directions. The direction of the gas flow may be alternated, for example by use of the valving on the gas feeds to each chamber box, along with the appropriate valve sequence for exhaust gas flow.

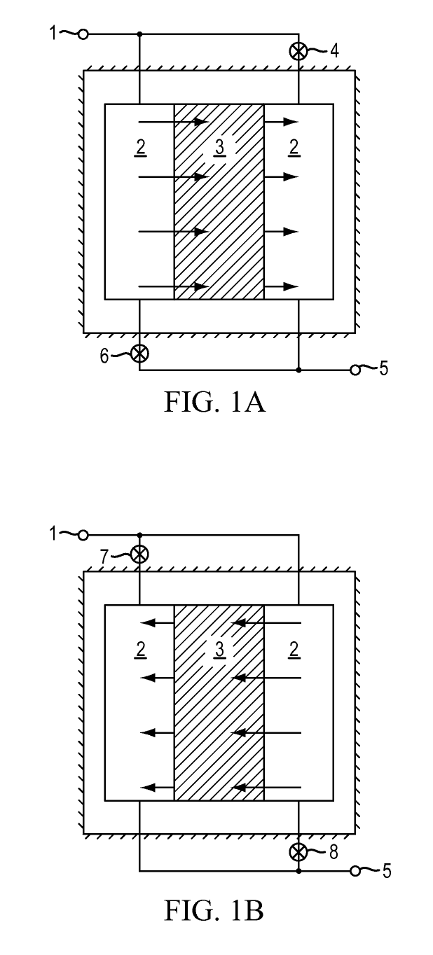

For example, in certain embodiments, there may be a gas diffusion chamber to the left of the cassette and a gas diffusion chamber to the right of the cassette. As depicted in the exemplary apparatus in FIG. 1A, gas 1 may flow through tubing connected to the gas diffusion chamber 2 on the left while a gas valve 4 on the right is closed, allowing for gas to flow from the left into the cassette 3. Gas from the gas diffusion chamber 2 on the right is permitted to exhaust through an exhaust opening 5, while an exhaust valve 6 on the left is closed. Thus, as depicted in the exemplary apparatus in FIG. 1A, the gas is allowed to flow from the left to the right through the cassette 3.

In the bidirectional flow furnace configuration disclosed herein, an alternate embodiment for gas flow in the same furnace may be utilized. In this alternate embodiment, depicted for example in FIG. 1B, gas 1 may flow through tubing connected to the gas chamber 2 on the right while a gas valve 7 on the left is closed, allowing for gas to flow from the right into the cassette 3. Gas from the gas diffusion chamber 2 on the left is permitted to exhaust through an exhaust opening 5, while an exhaust valve 8 on the right is closed. Thus, as depicted in FIG. 1B, the gas is allowed to flow from the right to the left through the cassette 3.

Other embodiments for bidirectional flow may be readily envisioned by those skilled in the art, such as applying gas flow from the top of the cassette to the bottom and from the bottom of the cassette to the top.

Exhaust gas flow from the diffusion chambers may be vented into a larger retort chamber and/or may be piped directly to exhaust ports on the retort chamber. In certain embodiments, an inert gas such as nitrogen, argon, and helium may be used.

The amount of gas flow through the shaped body can be regulated by any method known to those of skill in the art, for example by adjusting the input gas flow rates as well as amount of gas allowed to be vented around the shaped body versus through the shaped body. In certain embodiments, the gas flow may optionally be alternated during the cooling process as well.

In at least one additional exemplary embodiment, a bidirectional gas flow may be applied during the heat treatment and/or controlled oxidation of at least one honeycomb shaped body, wherein the process gas flows through the multiplicity of cells or channels of the honeycomb body from the inlet end to the outlet end.

During heat treatment, the process temperature of the furnace may, in various exemplary embodiments, be up to about 900° C., such as, for example, about room temperature to about 900° C., such as about 800° C. As a further example, the process temperature of the furnace for the heat treatment firing may be up to about 500° C. In certain embodiments, the shaped body is carbonized during the heat treatment process.

Moreover, during the heat treatment process, the shaped body may be soaked in a gas, such as nitrogen. The soak time may range from a few minutes to several hours in various embodiments, depending on the properties desired and flow rates and temperature conditions employed. For example, the soak time may range from 5 minutes to more than 48 hours, from 10 minutes to 20 hours, or from 30 minutes to 10 hours. It is well within the ability of those skilled in the art to adjust to the soak time, gas flow rates, and temperature to yield a shaped body having the desired properties for a particular application, such as, for example, mercury abatement.

Alternating the gas flow in the heat treatment process while the shaped body is being heated and/or during the soak time may, in certain embodiments, provide a means to substantially uniformly heat treat the shaped body over substantially all of its surface or thickness. In certain embodiments, the heat treatment process results in the carbon-based or ceramic body being carbonized. As discussed above, with gas flowing in only a single direction, the gas may not uniformly reach all surfaces of the shaped body (e.g., gas flow from the left to the right may yield a shaped body wherein the gas contacts the left side of the shaped body at a higher concentration than the gas contacts the right side of the shaped body). Bi-directional gas flow therefore may, in certain embodiments, allow for greater uniformity in the resultant shaped body, for example as gas flows from both the left and right, allowing for a more substantially uniform distribution of the gas. For example, a process employing bidirectional gas flow may lead to a more substantially uniformly carbonized and/or activated shaped body in certain exemplary embodiments.

In certain embodiments, the duration of the gas flow from a particular direction and the frequency of alternating the gas flow can be determined by control systems known in the art for valve sequencing of the gas inlet valving and exhaust valving. The duration of the gas flow in a given direction may range from a few minutes to several hours in various embodiments, such as, for example, from 5 minutes to 24 hours or from 5 minutes to 10 hours. The frequency with which the gas flow is alternated may be on the order of approximately 12 alterations per hour, such as 1, 6, or 12 alterations per hour, for example.

In certain embodiments wherein the heat treatment process results in the carbon-based or ceramic body being carbonized, the bidirectional gas flow disclosed herein may be performed at any temperature range. By way of example only, the temperature for carbonization may, in certain exemplary embodiments, be that range wherein the greatest extent of carbonization and organic volatilization may occur with the resin being carbonized. In certain embodiments, for example, the temperature of the furnace may range from about room temperature to 900° C., such as from 200° C. to 800° C. during the carbonization process.

During the controlled oxidation process, the shaped body to be processed may be set into the cassette and loaded into a furnace, such as a retort furnace, in a similar fashion as described above for the heat treatment process. Gas diffusion manifolds, ceramic setter blocks, and/or inner cassette frames may also be employed in a similar fashion to that described above for the heat treatment process. In certain embodiments, gas sealing can be maintained in the assembly, for example by use of ceramic felt material and/or close machine tolerances for interconnecting and/or sliding parts.

The shaped body may then be heated with gas flow in one or more directions, as described above. The flow can be alternated, for example by use of valving on gas feeds to each gas diffusion chamber along with the appropriate valve sequence for exhaust gas flow, as depicted in FIGS. 1A and 1B. In certain embodiments, exhaust gas flow from the gas diffusion chambers can be vented, such as into a larger retort chamber or piped directly to exhaust ports on a retort chamber.

It is well within the ability of those skilled in the art to choose the gas, temperature range, soak time, and other variables for the oxidation step to yield a shaped body, such as a carbon-based, inorganic cement, or ceramic body, having the desired properties. For example, in certain embodiments the process temperature of the furnace may be up to about 900° C., such as for example, about 800° C. during the controlled oxidation process.

In at least one exemplary embodiment, a gas such as carbon dioxide or a carbon dioxide/nitrogen mixture may be used to oxidize the shaped body, such as a shaped body comprising carbonaceous material. This may, in certain exemplary embodiments, be performed at a furnace temperature of about 500° C. or greater. In certain other embodiments, an inert gas such as nitrogen may be used in the controlled oxidation process. Optionally, this may be performed at a lower furnace temperature, such as less than about 500° C.

In certain embodiments of the controlled oxidation process, the shaped body may be soaked in a gas. This soaking allows for a more complete controlled oxidation of the shaped body. The shaped body may be soaked in any oxidizing gas known to those skilled in the art, such as, for example, carbon dioxide, and water (steam). In various exemplary embodiments, the soak time during the controlled oxidation process may range from a few minutes to several hours, depending on, for example, the properties desired and flow rates and temperature conditions employed. For example, the soak time may range from 5 minutes to more than 48 hours, from 10 minutes to 20 hours, or from 30 minutes to 10 hours.

According to certain embodiments disclosed herein, a single firing for heat treatment and a single controlled oxidation firing employing bidirectional gas flow may yield a shaped body, such as a carbon-based, inorganic cement, or ceramic body, that is more uniformly oxidized.

Because only a single controlled oxidation firing may be employed according to certain embodiments, after the controlled oxidation firing it is not, in certain exemplary embodiments, necessary to remove the shaped body from the furnace, turn it upside down, and then place it back in the furnace for a second controlled oxidation firing. The use of bidirectional gas flow may thus allow for the production of desirable shaped bodies with only a single controlled oxidation firing, resulting in decreased manufacturing time, decreased manufacturing costs, and a more uniformly oxidized shaped body.

One exemplary embodiment disclosed herein is a bidirectional gas flow furnace for the heat treatment and/or the controlled oxidation of a shaped body, such as a carbon-based, inorganic cement or ceramic body. In one embodiment, the bidirectional gas flow furnace comprises at least one gas inlet and at least two gas diffusion chambers connected to the at least one gas inlet. In certain embodiments, the gas diffusion chambers may each comprise a valve for regulating a flow of gas from the at least one gas inlet and a valve for exhausting the flow of gas from the at least two gas diffusion chambers. The bidirectional gas flow furnace described herein may further comprise at least one chamber for holding the shaped body in between the gas diffusion chambers and at least one exhaust opening.

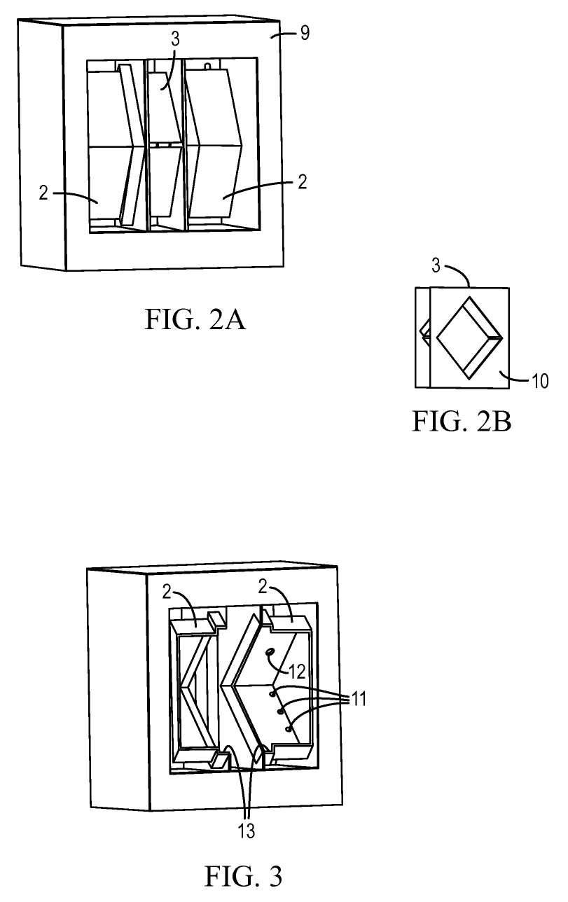

For example, FIG. 2A depicts an exemplary box retort furnace 9 for use with a bidirectional gas flow process. As shown in FIG. 2A, an exemplary furnace may comprise two gas chambers 2 on either side of a cartridge part holder or cassette 3, wherein the chambers 2 and cassette 3 are oriented in a vertical direction. It is known that applying a heat treatment process to a shaped body may result in a reduction in size of the shaped body. This reduction in size of the shaped body may destroy an adequate seal around the shaped body. By configuring the furnace in a vertical direction, for example wherein the gas chambers 2 are to the left and right of the cassette 3 and wherein the upper portion of the cassette 3 is free to move together with the shaped body as the shaped body's dimension changes, an adequate seal may be maintained around the shaped body to prevent the release of process gas.

FIG. 2B shows an exemplary cartridge part holder or cassette 3 in a vertical direction for use in a box retort furnace. The cassette 3 comprises a side shield 10. The side shield 10 contacts the gas chamber 2 to create a seal and to direct the gas to flow through and/or around the shaped body.

FIG. 3 shows a partial front isometric view of an exemplary box retort furnace for use with a bidirectional flow gas flow process, wherein, as depicted in FIG. 2A, the gas chambers 2 and cassette 3 are oriented in a vertical direction. At least one gas inlet port 11 allows gas flow into the cassette 3, and at least one gas exhaust port 12 allows gas flow out of the cassette 3. The furnace may comprise a recess cavity 13 for holding the side shield 10 of the cassette 3 in place.

Unless otherwise indicated, all numbers used in the specification and claims are to be understood as being modified in all instances by the term “about,” whether or not so stated. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary.

It is to be understood that both the foregoing general description and the following detailed description are exemplary and explanatory only and are not restrictive of the invention, as claimed.

The accompanying drawings, which are incorporated in and constitute a part of this specification, are not intended to be restrictive of the invention as claimed, but rather illustrate embodiments of the invention and, together with the description, serve to explain the principles of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the claims.

### EXAMPLES

The following examples are not intended to be limiting of the invention as claimed, and are merely prophetic in nature.

### Example 1

### Continuous Process for Combined Carbonization and Activation

An exemplary combined carbonization and oxidation process in a continuous furnace, such as, but not limited to, a continuous roller hearth, may be described as follows:

The furnace comprises an entrance purge chamber, a nitrogen heating and soak section, a carbon dioxide soak section, a nitrogen cooling section, and an exit purge chamber. In addition, each section is separated from the adjacent section by an interim purge chamber. Each section of the continuous furnace is comprised of one or more zones. Each zone can be either a direct radiant heated/cooled type zone or can be a convection heated/cooled type zone with gas atmosphere recirculation within the zone. Each individual zone is set at a desired temperature set point to establish a fixed temperature profile along the length of the continuous furnace. The temperature profile along the length of the continuous furnace is comprised of a heating temperature profile, a soak temperature profile, and a cooling temperature profile.

Shaped bodies to be carbonized and activated are conveyed into the entrance purge chamber of the furnace. The chamber contains an air atmosphere when the shaped bodies enter the chamber.

The atmosphere in the entrance purge chamber is then changed from an air atmosphere to a nitrogen atmosphere. The shaped bodies are then conveyed into the nitrogen heating and soak section of the furnace.

The shaped bodies are conveyed continuously through the zones in the nitrogen heating and soak section. The shaped bodies increase in temperature as they progress from zone to zone of increasing temperature until they reach and are maintained at the soak temperature of about 600° C. to 900° C. The temperatures in the final zones (soak zones) in the nitrogen heating and soak section are maintained at same soak temperature of about 600° C. to 900° C. If, for example, the shaped body is a honeycomb body, nitrogen may be flowed through the cells of honeycomb body with or without recirculation to heat and carbonize the honeycomb body as it progresses through the zones in the nitrogen heating and soak section. The direction of nitrogen flow can be periodically reversed within a zone from one direction to the opposite direction to more uniformly heat and carbonize the shaped body. Alternatively, the direction of the nitrogen flow may be maintained constant within each individual zone with the direction of nitrogen flow alternating in opposite directions from zone to zone to heat and carbonize the shaped bodies more uniformly.

Following carbonization in the heating and nitrogen soak section, the shaped bodies are conveyed into the interim purge chamber located between the nitrogen heating and soak section and the carbon dioxide soak section. The interim purge chamber contains a nitrogen atmosphere when the shaped bodies enter the chamber.

The atmosphere in the interim purge chamber is then changed from a nitrogen atmosphere to a carbon dioxide atmosphere. The shaped bodies are then conveyed into the carbon dioxide soak section of the furnace.

The temperatures in the zones of the carbon dioxide soak section are maintained at same soak temperature of about 600° C. to 900° C. The shaped bodies are conveyed continuously through the zones in the carbon dioxide soak section. The temperature of the shaped bodies is maintained at the carbon dioxide soak temperature of about 600° C. to 900° C. as the shaped bodies are conveyed through the zones in the carbon dioxide soak section. Carbon dioxide is flowed through the shaped bodies with or without recirculation to activate the shaped bodies as they progress through the zones in the carbon dioxide soak section. The direction of carbon dioxide flow can be periodically reversed within a zone from one direction to the opposite direction to more uniformly activate and soak the shaped body. Alternatively, the direction of the carbon dioxide flow can be maintained constant within each individual zone with the direction of carbon dioxide flow alternating in opposite directions from zone to zone to more uniformly activate and soak the shaped bodies.

Following activation in the carbon dioxide soak section, the shaped bodies are conveyed into the interim purge chamber located between the carbon dioxide soak section and the nitrogen cooling section. The interim purge chamber contains a carbon dioxide atmosphere when the shaped bodies enter the chamber.

The atmosphere in the interim purge chamber is then changed from a carbon dioxide atmosphere to a nitrogen atmosphere. The shaped bodies are then conveyed into the nitrogen cooling section of the furnace.

The shaped bodies are conveyed continuously through the zones in the nitrogen cooling section. The shaped bodies decrease in temperature as they progress from zone to zone of decreasing temperature until they reach a low enough temperature to exit the furnace (for example, less than about 100° C.). Nitrogen is flowed through the shaped bodies with or without recirculation to cool the shaped bodies as they progress through the zones in the nitrogen cooling section. The direction of nitrogen flow can be periodically reversed within a zone from one direction to the opposite direction to more uniformly cool the shaped bodies. Alternatively, the direction of the nitrogen flow can be maintained constant within each individual zone with the direction of nitrogen flow alternating in opposite directions from zone to zone to more uniformly cool the shaped bodies.

Following cooling, the shaped bodies are conveyed into the exit purge chamber. The chamber contains a nitrogen atmosphere when the shaped bodies enter the chamber. The atmosphere in the exit purge chamber is then changed from a nitrogen atmosphere to an air atmosphere. The shaped bodies are then conveyed out of the exit purge chamber of the furnace.

To those skilled in the art, it is readily understood that carbonization and activation processes may also be conducted in separate continuous cycles.

### Example 2

### Batch Process for Combined Carbonization and Activation

An exemplary process cycle for combined carbonization and controlled oxidation (activation) heating cycle may be described as follows. The cycle begins with the furnace in the cold condition. The furnace comprises a heating chamber in which gases such as nitrogen and carbon dioxide can be flowed in.

Shaped bodies to be processed are loaded into the chamber. The chamber is purged with an inert gas such as nitrogen until a low level of oxygen is attained, typically less than 1% oxygen. After purging, the process gas is flowed into the furnace while the furnace is heated to temperatures of about 600° C. to 900° C. to carbonize the shaped bodies. In certain embodiments, nitrogen gas may be used. During this operation, gas recirculation may be used for heating the shaped bodies from room temperature to a temperature of about 600° C. to 900° C. The direction of the gas and/or air flow may be alternated (bidirectional flow) during the heating of the shaped body. When the temperature of the chamber reaches about 600° C. to 900° C., the shaped bodies can be soaked at a temperature to complete the carbonization of the shaped bodies. Alternating gas flow may also be employed while the shaped bodies are soaking.

Upon completion of the carbonization step, the furnace temperature can be ramped to the desired activation temperature with the same carbonization gas atmosphere or an activation gas mixture. When the activation temperature of about 700° C. to 900° C. is reached, the shaped bodies may be held at that temperature to soak the bodies to allow completion of activation. Carbon dioxide gas with or without nitrogen may be used for activation, as well as other gases known to those skilled in the art. During the ramp and soak for activation, the gas flow may be alternated up-to-down and down-to-up during the soak time to attain the desire activation properties with or without gas recirculation.

Upon completion of the activation step, the shaped bodies are then cooled in the presence of a carbon dioxide with or with nitrogen gas present. The direction of the gas flow may be alternated in the cooling step. The atmosphere during cooling can be changed to an inert atmosphere with a gas such as nitrogen. During this cooling, gas recirculation may be used to improve thermal uniformity and heat transfer for cooling. When the shaped bodies reach a low enough temperature for handling, they can be removed from the furnace.

To those skilled in the art, it is readily understood that carbonization and activation processes can be conducted in separate cycles as well.

What is claimed is:

1. A process for firing a shaped body comprising:
placing the shaped body into a furnace;
applying a gas flow to the shaped body in the furnace from a first direction; and
subsequently applying a gas flow to the shaped body in the furnace from a second direction.

2. The process according to claim 1, wherein the gas is chosen from at least one of nitrogen and carbon dioxide.

3. The process according to claim 1, wherein the furnace reaches a temperature up to about 900° C.

4. The process according to claim 1, wherein after the gas flow is alternated from the first direction to the second direction, the gas flow is alternated back to the first direction and subsequently back to the second direction at least one additional time.

5. The process according to claim 1, wherein the shaped body is a carbon-based, inorganic cement, or ceramic body.

6. The process according to claim 5, wherein the process activates the carbon-based, inorganic cement, or ceramic body.

7. The process according to claim 6, wherein the process activates the carbon-based, inorganic cement, or ceramic body after one firing.

8. The process according to claim 5, wherein the process carbonizes the carbon-based or ceramic body.

9. The process according to claim 8, wherein the process carbonizes the carbon-based or ceramic body after one firing.

10. The process according to claim 5, wherein the process comprises a second firing, and further wherein the process carbonizes the carbon-based or ceramic body after the first firing, and activates the carbon-based or ceramic body after the second firing.

11. A shaped body that has been produced by a firing process, said firing process comprising:
placing the shaped body into a furnace;
applying a gas flow to the shaped body in the furnace from a first direction; and
subsequently applying a gas flow to the shaped body in the furnace from a second direction.

12. The shaped body according to claim 11, wherein said shaped body is a carbon-based, inorganic cement, or ceramic body.

13. The shaped body according to claim 11, wherein the gas is chosen from at least one of nitrogen and carbon dioxide.

14. The shaped body according to claim 11, wherein the furnace reaches a temperature up to about 900° C.

15. The shaped body according to claim 11, wherein after the gas flow is alternated from the first direction to the second direction, the gas flow is alternated back to the first direction and subsequently back to the second direction at least one additional time.

16. The carbon-based, inorganic cement, or ceramic body according to claim 12, wherein the carbon-based, inorganic cement, or ceramic body is activated.

17. The carbon-based, inorganic cement, or ceramic body according to claim 16, wherein the carbon-based, inorganic cement, or ceramic body is activated after one firing.

18. The carbon-based or ceramic body according to claim 12, wherein the carbon-based or ceramic body is carbonized.

19. The carbon-based or ceramic body according to claim 18, wherein the carbon-based or ceramic body is carbonized after one firing.

20. The carbon-based or ceramic body according to claim 12, wherein the firing process comprises a second firing, and further wherein the carbon-based or ceramic body is carbonized after the first firing and activated after the second firing.

21. A bidirectional gas flow furnace for at least one of heat treatment or controlled oxidation of a shaped body comprising:
at least one gas inlet;
at least two gas diffusion chambers connected to said at least one gas inlet, wherein the at least two gas diffusion chambers each comprise (a) a valve for regulating a flow of gas from the at least one gas inlet, and (b) a valve for exhausting the flow of gas from the at least two gas diffusion chambers;
at least one chamber for holding the shaped body in between said at least two gas diffusion chambers; and
at least one exhaust opening.
